(19) United States
(12) Patent Application Publication
(10) Pub. No.: US 2021/0369545 A1
(43) Pub. Date: Dec. 2, 2021

(54) Method and system for smart navigation for the visually impaired

(71) Applicant: Arko Ayan Ghosh, Tampa, FL (US)

(72) Inventor: Arko Ayan Ghosh, Tampa, FL (US)

(21) Appl. No.: 16/842,706

(22) Filed: Apr. 7, 2020

(51) Int. Cl. A61H 3/06; G01S 15/52; G01S 15/08; G01S 15/89; G01S 7/292; G10L 13/027; G06K 9/62

(52) U.S. Cl. CPC A61H 3/061; G01S 15/526; G01S 15/08; G06K 9/6267; G01S 7/292; G10L 13/027; G01S 15/89

(57) ABSTRACT

In 2019, the World Health Organization stated that globally, approximately 2.2 billion people live with some form of vision impairment. Visual impairment limits the ability to perform everyday tasks and adversely affects the ability to interact with the surrounding world, thus discouraging individuals navigating unpredictable and unknown environments. The present invention is a method and a system to define and develop a smart navigation intelligent cane (i-Cane) that enables a visually impaired person to navigate his or her environment. The method and the system detects objects along the path of the visually impaired person, measures the distance of the objects from the person, identifies the objects, uses speech to alert the person of the approaching objects, the type of objects obstructing the path, and the distance between the objects and the person.

### FIELD OF INVENTION

The present invention is a method and a system to define and develop a smart navigation intelligent cane (i-Cane) that enables a visually impaired person to navigate his or her environment.

### BACKGROUND OF THE INVENTION

In 2019, the World Health Organization stated that globally, approximately 2.2 billion people live with some form of vision impairment, of whom 1 billion people have moderate to severe vision impairment. Findings from the “Summary Health Statistics for U.S. Adults: National Health Interview Survey, 2012” established that an estimated 20.6 million adult Americans (or nearly 10% of all adult Americans in 2012) reported they either “have trouble” seeing, even when wearing glasses or contact lenses, or that they are blind or unable to see at all. Any form of visual impairment is severe enough to cause a significant impact on the course of their daily living. Specifically, their ability to move around and recognize obstacles may be compromised as they carry out their day-to-day life.

The world is full of dangers and wonders which are avoided or appreciated with our vision. The physical world poses the greatest challenge to the visually impaired person. How does one know what and where things are and how to obtain them? How does one understand where he/she wants to go without the danger of colliding with the objects around them?

Blind individuals may be discouraged from moving freely and comfortably. What can help them to identify the approaching objects in their path of navigation and determine how far these objects are from the individuals, when they are moving in a house or walking in a mall or strolling through isles in a grocery store?

Therefore, there is a need to define a method and a system to solve the problem and the challenge faced with visually impaired persons described above.

### SUMMARY OF THE INVENTION

The present invention describes a method and a system for smart navigation for the visually impaired. The method defines an approach to develop a smart navigation intelligent cane (i-Cane) that enables a visually impaired person to navigate his or her environment. There are three main steps in this method:
detecting the approaching objects in the path of a visually impaired person using an ultrasonic sensor and calculating the distance of the objects from the visually impaired person carrying the i-Cane
identifying and classifying the approaching objects
generating voice alert indicating the type of the objects and the distance of the objects from the visually impaired person carrying the i-Cane warning the person of the approaching objects

The system to develop smart navigation for the visually impaired includes a computing runtime and the necessary software components. The computing runtime includes:
a mini portable computing platform, an ultrasonic sensor, and a camera
a set of software components that realize the method steps described above

The software components include:
object detection component
object identification component that in turn includes image capture component, classify image component, and computer vision component
voice alert generation component that includes speech synthesis component

### BRIEF DESCRIPTION OF THE DRAWINGS

FIG. 1 illustrates the main process flow and steps for the method defined in this invention.

FIG. 2 depicts the system behind i-Cane and the underlying building blocks of computing runtime and software components.

FIG. 3 illustrates the connections between a mini portable computing platform such as the single-board computer Raspberry Pi 3, an ultrasonic sensor such as HC-SR04 and the circuitry to connect the sensor to the Raspberry Pi.

### DETAILED DESCRIPTION OF THE INVENTION

Visual impairment has a severe impact on the course of daily living, discouraging individuals from moving freely in an unknown environment. The world is full of dangers and wonders which are avoided or appreciated with our vision. The physical world poses the greatest challenge for the visually impaired person. How does one know what and where things are and how to obtain them? How does one understand where he/she wants to go without the danger of colliding with things around them?

Blind individuals may be discouraged from moving freely and comfortably. What can help them to identify the approaching objects in their path of navigation and determine the distance of the objects from the individuals, when they are moving in a house or walking in a mall or strolling through isles in a grocery store?

The purpose of this invention is to define a method and a system to develop a simple but affordable way to assist visually impaired persons to navigate around their environment. The method defines an approach to develop a smart navigation intelligent cane (i-Cane) that aids a visually impaired person to move around the surroundings:
by first detecting the approaching objects in the path of the visually impaired person carrying the i-Cane, finding the distance between the approaching objects and the person, and then identifying the objects leveraging ultrasonic sensor, camera, and computer vision technology and
finally, by generating a voice/speech alert for the visually impaired person in natural language using speech synthesis technology

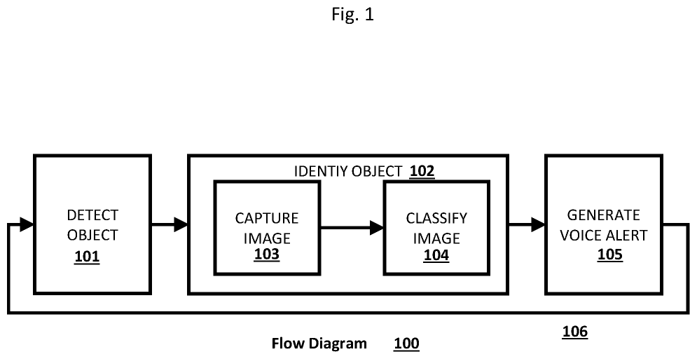

In FIG. 1, the Flow Diagram 100 shows the method developed in this invention and its overall flow and key steps. The key steps in this method are:
Detect Object (as shown by 101 in FIG. 1)—As the visually impaired person carrying the i-Cane travels through a path, first, detect the approaching object in the path using an ultrasonic sensor and then calculate the distance between the object and the person carrying the i-Cane
Identify Object (as shown by 102 in FIG. 1)—Next, identify the object, if the distance between the approaching object and the visually impaired person carrying the i-Cane meets a certain distance threshold:
   by capturing an image (as shown by 103 in FIG. 1) of the approaching object and
   by classifying and labeling the image of the approaching object (as shown by 104 in FIG. 1) using computer vision technology
Generate Voice Alert (as shown by 105 in FIG. 1)—Finally, generate voice alert using speech synthesis technology to indicate the type of the object and the distance of the object from the visually impaired person carrying the i-Cane, forewarning the person about the approaching object in a natural language so that the person can take some corrective actions to avoid the potential collision with the object
Continue with the flow, as shown by 106 in FIG. 1, as the virtually impaired person continues with his/her path and as the objects appear in the path

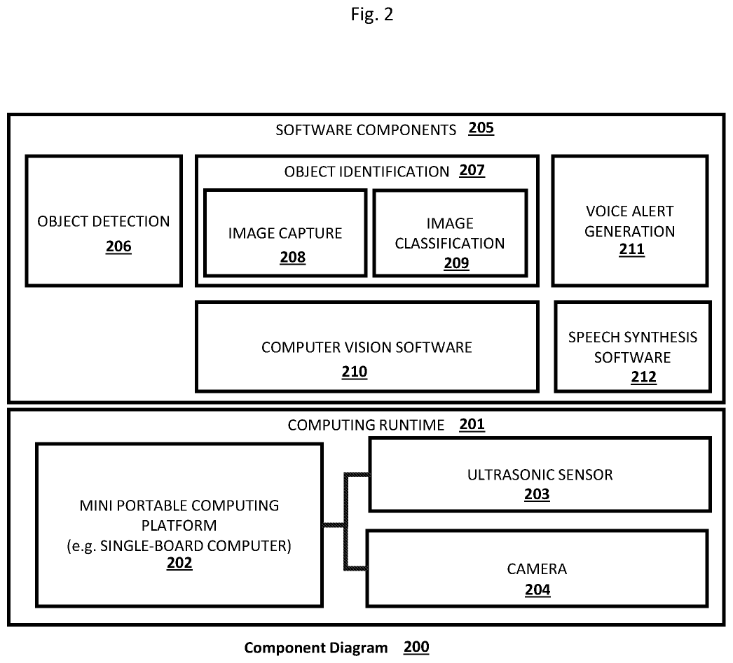

As part of this invention, a system is also defined to demonstrate the method developed in this invention. FIG. 2 illustrates the Component Diagram 200 for the system that implements the method and its flow as depicted by 100 in FIG. 1. The system for designing and developing the i-Cane is composed of Computing Runtime (as shown by 201 in FIG. 2) and Software Components (as shown by 205 in FIG. 2). The Computing Runtime (as shown by 201 in FIG. 2) includes a single-board Mini Portable Computing Platform (as shown by 202 in FIG. 2) providing an execution environment for the software components implementing the method described above. The Computing Runtime (as shown by 201 in FIG. 2) also enables the single-board Mini Portable Computing Platform (as shown by 202 in FIG. 2) to interface with an Ultrasonic Sensor (as shown by 203 in FIG. 2) and a Camera (as shown by 204 in FIG. 2). A representative computing runtime for the defined system can be made of a Raspberry Pi 3 as the single-board mini portable computing platform, an HC-SR04 as the ultrasonic sensor, and a Pi Camera as the camera.

The Software Components (as shown by 205 in FIG. 2) includes:
Object Detection (as shown by 206 in FIG. 2) detects the approaching object in the path of the visually impaired person carrying the i-Cane using an ultrasonic sensor and calculates the distance of the object from the person carrying the i-Cane.
Object Identification (as shown by 207 in FIG. 2) identifies the object if the distance between the approaching object and the visually impaired person carrying the i-Cane is less than a certain distance threshold. The Image Capture sub-component (as shown by 208 in FIG. 2) within the Object Identification component takes a picture of the approaching object using the camera. And then, the Image Classification sub-component (as shown by 209 in FIG. 2) labels and classifies the image using the Computer Vision Software (as shown by 210 in FIG. 2) running on the cloud.
Voice Alert Generation (as shown by 211 in FIG. 2) generates a voice alert using the Speech Synthesis Software (as shown by 212 in FIG. 2) to inform the visually impaired person carrying the i-Cane of the approaching object, its type and the distance between the object and the person, forewarning the person of the approaching object.

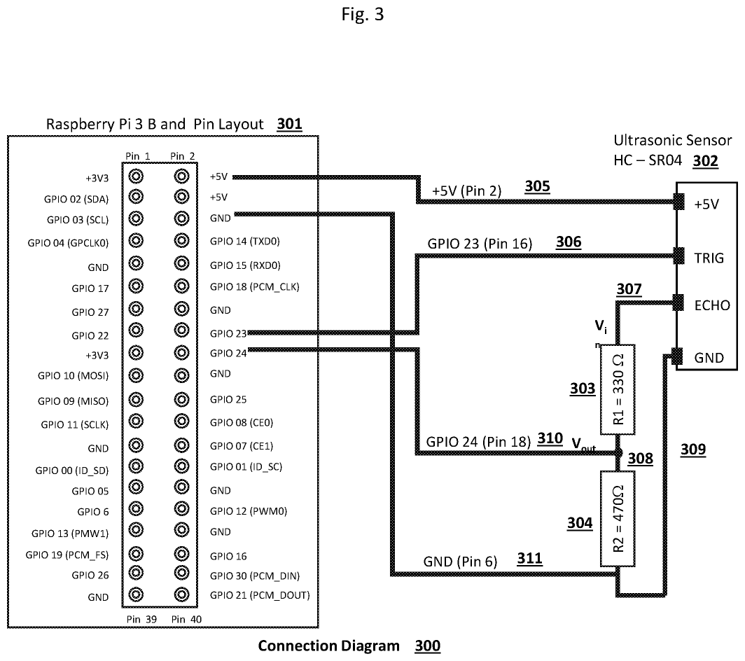

In FIG. 3, the Connection Diagram 300 illustrates the connection between the Raspberry Pi 3 (the single-board mini portable computing platform) and HC-SR04 (the ultrasonic sensor) and the circuitry in between connecting the two hardware components. The Pi Camera is directly connected to the camera port on the Raspberry Pi 3 using a camera cable. The system consisting of the Raspberry Pi 3 mini portable computing platform connected with the HC-SR04 ultrasonic sensor and the Pi Camera is mounted on the i-Cane.

301 in FIG. 3, Illustrates the single-board mini portable computing platform Raspberry Pi 3 and its pin layout. 302 in FIG. 3 shows the ultrasonic sensor HC-SR04 and its four pins, namely, 5V Power, TRIGGER (TRIG), ECHO, GROUND (GND).

Connecting Ultrasonic Sensor to Raspberry Pi 3
The 5V Power pin of the ultrasonic sensor is connected to the GPIO 5V pin (Pin number 2) of the Raspberry Pi 3 as shown by 305 in FIG. 3.
The TRIG pin of the ultrasonic sensor is connected to the GPIO 23 pin (Pin number 16) of the Raspberry Pi 3 as shown by 306 in FIG. 3.
The ECHO pin of the ultrasonic sensor is connected to the resistor R1 (330Ω, represented by 303 in FIG. 3) as shown by 307 in FIG. 3. The other end of the resistor R1 is connected to the resistor R2 (470Ω, represented by 304 in FIG. 3) as shown by 308 in FIG. 3.
The other end of resistor R2 is connected to GND pin of the ultrasonic sensor as shown by 309 in FIG. 3. And the common point of the resistor R2 and GND pin of the ultrasonic sensor is connected to GPIO GND pin (Pin number 6) of the Raspberry Pi 3 as shown by 311 in FIG. 3.
The common point of R1 and R2 resistors is connected to the GPIO 24 pin (Pin number 18) of the Raspberry Pi 3 as shown by 311 in FIG. 3. The GPIO 24 pin sits between the resistors R1 and R2 thereby forming a parallel circuit and hence, reducing the voltage to approximately 3V from 5V. Mathematically, Vₒᵤₜ=Vᵢₙ×R2/(R1+R2) where Vᵢₙ=5V, R1+R2=800 Ω and R2=470 Ω and substituting the values Vₒᵤₜ is approximately equal to 3V.

A software program using Python programming language is run on the Raspberry Pi 3 mini portable computing platform, as shown by 202 in FIG. 2 and as shown by 301 in FIG. 3, connected to the ultrasonic sensor, as shown by 203 in FIG. 2 and as shown by 302 in FIG. 3 through the circuitry as shown in FIG. 3 and connected to the Pi Camera, as shown in 204 in FIG. 2.
Object Detection component triggers a signal to the ultrasonic sensor then waits to receive the echo back from the sensor and calculates the distance between the ultrasonic sensor on the i-Cane and the approaching object using the formula:

S=2D/t, therefore, D=(S×t)/2
where,
S is Speed of sound, so S=34030 cm/s
D is Distance between the approaching object and sensor
t is Time taken for the sensor to receive the echo back
lithe distance between the approaching object and the visually impaired person carrying the i-Cane is greater than a distance threshold value (e.g. 150 cm) the system does not attempt to identify the approaching object or generate a voice alert, continuing to detect the subsequent approaching object. The distance threshold value is configurable by visually impaired person.
Object Identification is composed of Image Capture and Image Classification sub-components. The Image Capture sub-component takes the picture of the approaching object using the Pi Camera. The Image Classification sub-component calls the Computer Vision Software component on a cloud platform to determine the label annotation of the image and classifies the image based on the labels with top relevancy scores.
Voice Alert Generation component generates an audio alert using the Speech Synthesis software indicating the type of the approaching object and the distance between the approaching object and the visually impaired person carrying the i-Cane, thereby alerting the person of the approaching object so that the person can take some corrective actions to avoid the potential collision with the object.

### NON-PATENT CITATIONS

WHO. World report on vision. World Health Organization, 2019.
Blackwell, Debra L, Lucas, Jacqueline W, and Clarke, Tainya C. “Summary Health Statistics for U.S. Adults: National Health Interview Survey, 2012”. National Center for Health Statistics. Vital and Health Statistics 10(260), 2014.
Upton, Eben, and Gareth Halfacree. Raspberry Pi: User Guide. John Wiley & Sons, 2013.
Monk, Simon. Programming the Raspberry Pi, Second Edition: Getting Started with Python. McGraw-Hill Education, 2015.
McManus, Sean, and Mike Cook. Raspberry Pi for Dummies. John Wiley & Sons, 2013.

1. A method to define and develop a smart navigation intelligent cane (i-Cane) that aids a visually impaired person to move around the surroundings, the method comprising of:
first, detecting the approaching objects along the path of the visually impaired person carrying the i-Cane using an ultrasonic sensor and then calculate the distance of the objects from the person carrying the i-Cane (Detect Object)
next, identifying the objects, if the distance between the approaching objects and the visually impaired person carrying the i-Cane meets a certain distance threshold (Identify Object):
by capturing an image of the approaching objects (Capture Image) and
by labeling and classifying the image of the approaching objects using computer vision technology (Classify Image)
finally, generating a voice alert using speech synthesis technology to indicate the type of the object and the distance between the object and the visually impaired person carrying the i-Cane, forewarning the person of the approaching object in a natural language (Generate Voice Alert)
and continuing the flow and repeating steps of object detection, object identification (image capture and classification), voice alert generation, as the virtually impaired person continues with his/her path and as the objects appear in the path.

2. A system for implementing and demonstrating the method, as described above, to define and develop a smart navigation intelligent cane (i-Cane) that enables a visually impaired person to navigate the environment, the system comprising of:
a computing runtime that consists of:
a single-board mini portable computing platform such as the Raspberry Pi 3, mounted on an intelligent cane, i-Cane, providing an execution environment for the software components implementing the method described above
an ultrasonic sensor such as HC-SR04 connected to single-board mini portable computing platform using a circuitry
a camera such as the Pi Camera connected to the camera port on the single-board mini portable computing platform using a camera cable
a software program implementing multiple software components that
detects the approaching object in the path of the visually impaired person carrying the i-Cane using an ultrasonic sensor and calculates the distance of the object from the person carrying the i-Cane
triggers signals to the ultrasonic sensor to measure the distance of the obstacle and then waits to receive the echo back from the sensor
calculates the distance between the ultrasonic sensor on the i-Cane and the approaching object using the formula
S=2D/t, therefore, D=(S×t)/2
where,
S is Speed of sound, so S=34030 cm/s
D is Distance between the approaching object and sensor
t is Time taken for the sensor to receive the echo back
continues to detect the subsequent approaching objects and doesn't attempt to identify the approaching object or generate a voice alert, if the distance between the approaching object and the visually impaired person carrying the i-Cane is greater than a distance threshold value that is configurable for a given person
captures an image of the approaching objects by interfacing with a camera such as the Pi Camera, if the distance between the approaching object and the visually impaired person carrying the i-Cane is less than the distance threshold value
identifies the objects by
calling the computer vision software passing the captured image
classifying the image based on the label annotations and the corresponding relevancy scores returned back from the computer vision software
generates an audio alert using speech synthesis software indicating the type of the approaching object and the distance between the approaching object and the visually impaired person carrying the i-Cane, thereby alerting the person of the approaching object.
